(19) United States
(12) Patent Application Publication
(10) Pub. No.: US 2016/0302262 A1
(43) Pub. Date: Oct. 13, 2016

(54) HEATING PAD

(71) Applicant: Wei Hsu, New Taipei City (TW)

(72) Inventor: Wei Hsu, New Taipei City (TW)

(73) Assignee: Weistech Technology Co., Ltd., New Taipei City (TW)

(21) Appl. No.: 15/064,582

(22) Filed: Mar. 8, 2016

(30) Foreign Application Priority Data
Apr. 9, 2015 (TW) 104205256

(51) Int. Cl. H05B 3/36; H05B 3/04; H05B 3/54

(52) U.S. Cl. CPC H05B 3/36; H05B 3/54; H05B 3/04

(57) ABSTRACT

The heating pad includes a flexible circuit board having heating elements; two waterproof films sealing the flexible circuit board; and an electric wire connecting the flexible circuit board.

### BACKGROUND OF THE INVENTION

1. Technical Field

The invention relates to electric heaters, particularly to portable heaters serving as hand warmers.

2. Related Art

In cold winter, to keep bodies warm, people may wear various warm clothing. However, the more warm clothing is worn, the more inconvenient people's movements are.

Some manufacturers provide clothing with electric heaters. However, such clothing is too thick and heavy to be easily carried. Also, such clothing is not waterproof, it may be dangerous if it is wetted.

### SUMMARY OF THE INVENTION

An object of the invention is to provide a waterproof heating pad which can be used underwater.

To accomplish the above object, the invention includes a flexible circuit board having heating elements; two waterproof films sealing the flexible circuit board; and an electric wire connecting the flexible circuit board.

### BRIEF DESCRIPTION OF DRAWINGS

FIG. 1 is an exploded view of the first embodiment of the invention;

FIG. 2 is another exploded view of the first embodiment of the invention;

FIG. 3 is an assembled view of the first embodiment of the invention;

FIG. 4 is an exploded view of the second embodiment of the invention;

FIG. 5 is an exploded view of FIG. 4;

FIG. 6 is an enlarged view of the controller of the second embodiment of the invention;

FIG. 7 is another exploded view of the second embodiment of the invention; and

FIG. 8 is an assembled view of the second embodiment of the controller of the invention.

### DETAILED DESCRIPTION

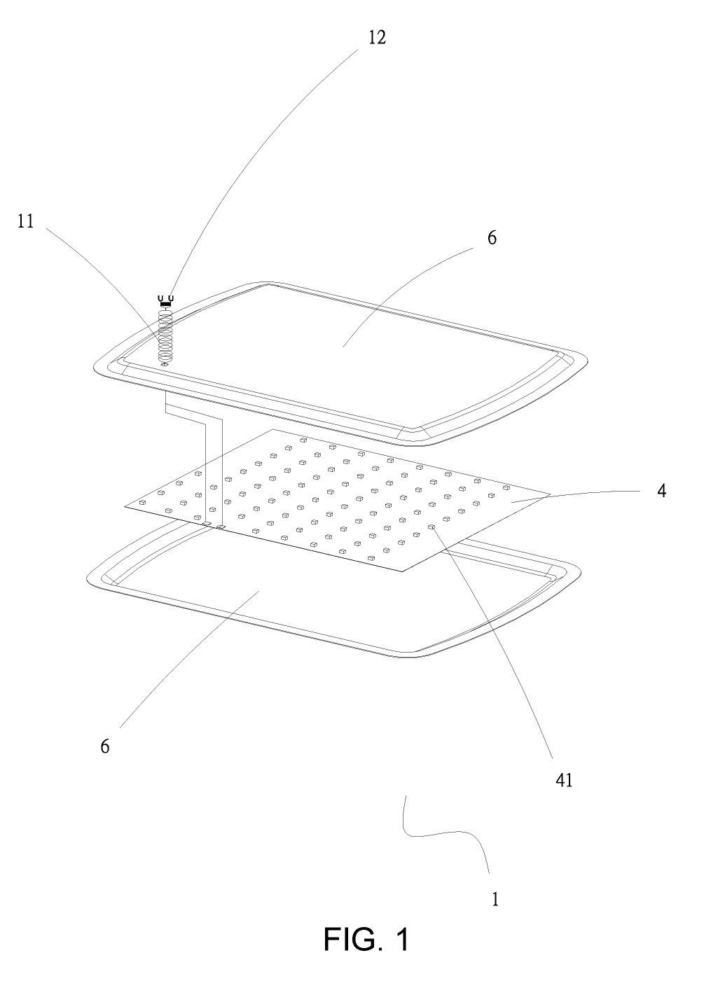

Please refer to FIG. 1. The heating pad of the invention includes a flexible circuit board 4, two waterproof films 6 and an electric wire 11. The flexible circuit board 4 has heating elements 41. The two waterproof films 6 are the same in shape and sizes and are adhered at their peripheries to completely seal the flexible circuit board 4. The electric wire 11 connects the flexible circuit board 4. The electric wire 11 may be retractable and is provided with a connector 12 for connecting an electric power source.

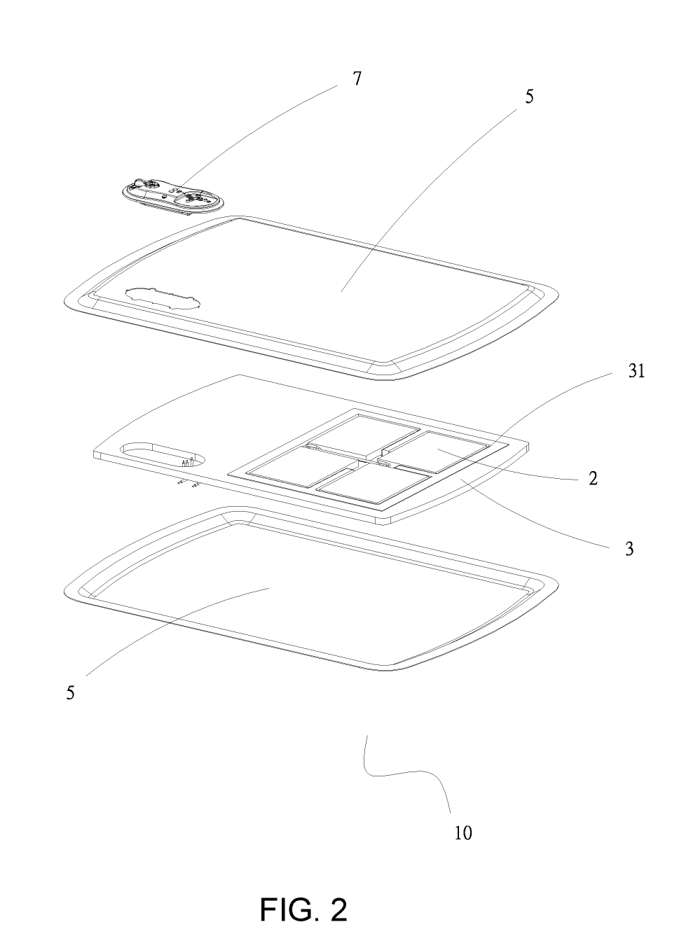

Please refer to FIG. 2. The invention further includes a battery pack 10. The battery pack 10 includes batteries 2, an intermediate layer 3, two waterproof covers 5 and a controller 7. The intermediate layer 3 is formed with holes 31 for receiving the batteries 2. The two waterproof covers 5 correspond to each other in shape and size to be adhered to form a room therein for receiving the batteries 2 and the intermediate layer 3. The controller 7 is received in the room formed by the two waterproof covers 5. One side of the controller 7 is exposed from one of the waterproof covers 5.

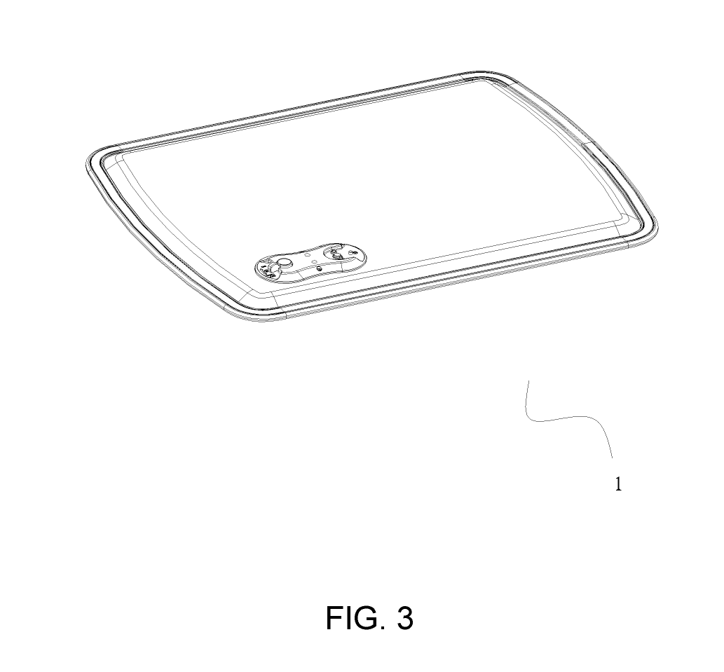

The battery pack 10 can be associated with the heating pad 1 through connection between the connector 12 with a corresponding connector (not shown) of the controller 7 as shown in FIG. 3. A user may buy a plurality of battery packs 10 to use.

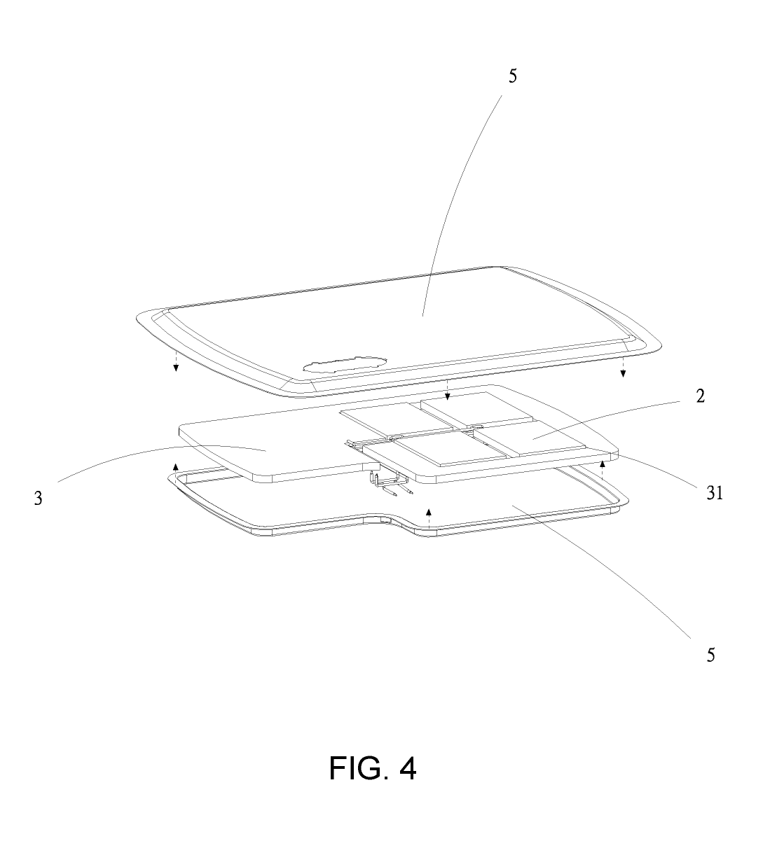

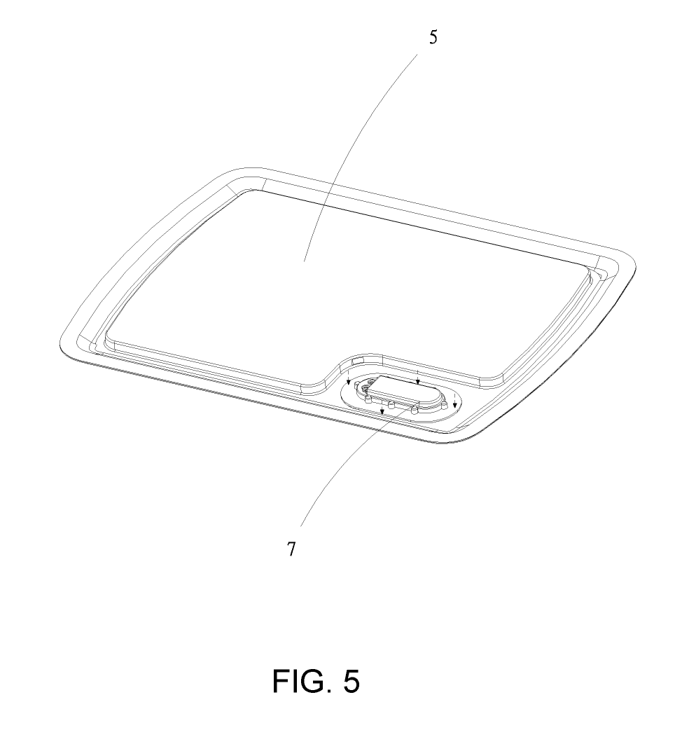

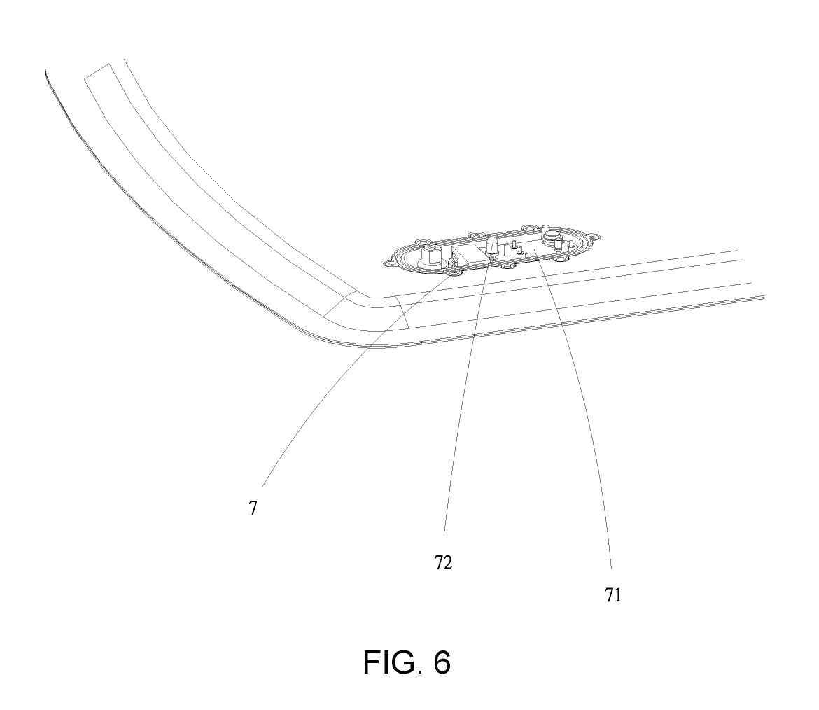

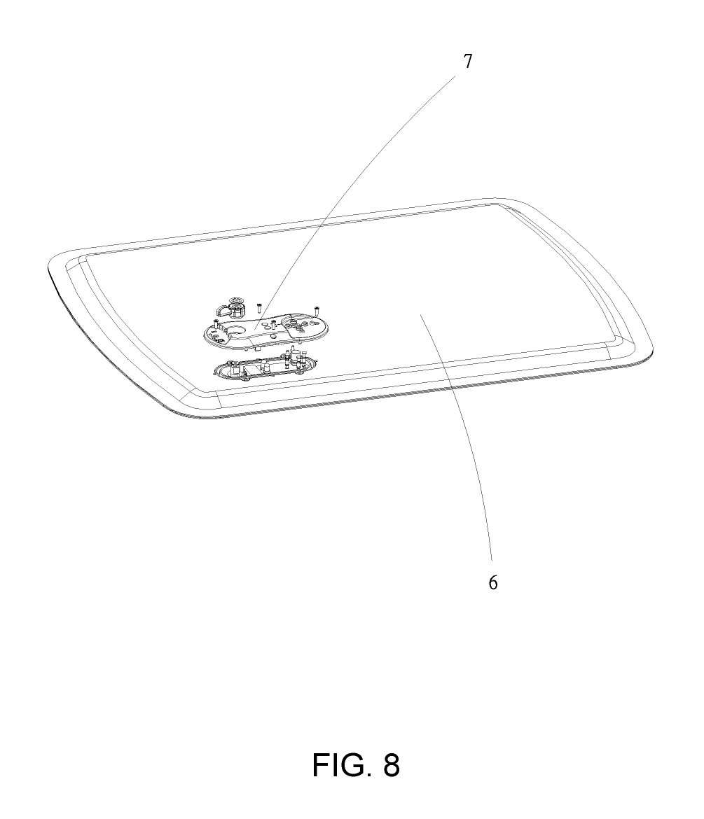

Please refer to FIGS. 4-8, which show another embodiment of the invention. This embodiment includes batteries 2, an intermediate layer 3, a flexible circuit board 4, two waterproof covers 5, two waterproof films 6 and a controller 7.

In this embodiment, the batteries 2 are rechargeable and are electrically connected to the flexible circuit board 4. Also, a soft partition is disposed between two adjacent batteries 2 to make flexibility.

The intermediate layer 3 is formed with holes 31 for receiving the batteries 2. The intermediate layer 3 may be a waterproof fabric or a sponge.

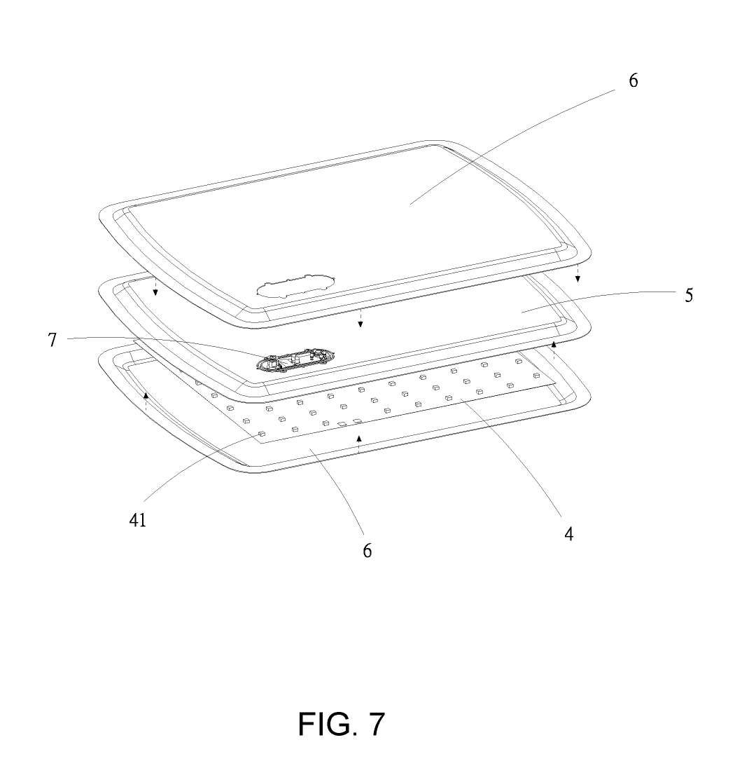

The flexible circuit board 4 is electrically connected to the batteries 2 and has heating elements 41 as shown in FIG. 7. The heating elements 41 are soldered on the flexible circuit board 4 with water treatment.

The two waterproof covers 5 correspond to each other in shape and size to be adhered to form a room therein for receiving the batteries 2 and the intermediate layer 3. The waterproof covers 5 may be made of PVC.

The waterproof covers 5 and the flexible circuit board 4 are accommodated in the two waterproof films 6. All components are processed with water treatment and are completely sealed in the waterproof films 6 with 40 meters water-resistance.

The controller 7 is electrically connected to the batteries 2 and includes a circuit board 71 and an LED for indication. The controller 7 performs controls of charging, switching and temperature adjustment. The controller 7 is received in the waterproof films 6. One side of the controller 7 is exposed from one of the waterproof films 6.

Preferably, nine heating elements 41 is placed in each 5 square centimeter and a distance between any two adjacent heating elements 41 is 2.5 centimeters. Each heating element has a resistance of 9 ohms.

The two waterproof covers 5 and the two waterproof covers 6 are separately adhered by ultrasonic welding. As a result, two waterproof structures are obtained. The batteries 2 on the flexible circuit board 4 can make flexibility so that the heating pad can be bent to attach a human body.

It will be appreciated by persons skilled in the art that the above embodiments have been described by way of example only and not in any limitative sense, and that various alterations and modifications are possible without departure from the scope of the invention as defined by the appended claims.

What is claimed is:

1. A heating pad comprising:
a flexible circuit board having heating elements;
two waterproof films sealing the flexible circuit board; and
an electric wire connecting the flexible circuit board.

2. The heating pad of claim 1, wherein the electric wire is provided with a connector.

3. The heating pad of claim 1, wherein the heating elements are soldered on the flexible circuit board.

4. The heating pad of claim 1, further comprising a battery pack comprising:
batteries;
an intermediate layer formed with holes for receiving the batteries two waterproof covers adhered to form a room therein for receiving the batteries and the intermediate layer; and
a controller, received in the room formed by the two waterproof covers, and one side of the controller being exposed from one of the waterproof covers.

5. The heating pad of claim 4, wherein the two waterproof covers correspond to each other in shape and size.

6. The heating pad of claim 1, wherein the two waterproof films correspond to each other in shape and size.
